(19) United States
(12) Patent Application Publication
(10) Pub. No.: US 2015/0049009 A1
(43) Pub. Date: Feb. 19, 2015

(54) SYSTEM-WIDE HANDWRITTEN NOTES

(71) Applicant: Lenovo (Singapore) Pte. Ltd., Singapore (SG)

(72) Inventors: Karen Ruth Kluttz, Raleigh, NC (US); Daryl Cromer, Cary, NC (US); Howard Locker, Cary, NC (US); Aaron Michael Stewart, Raleigh, NC (US); Michaela Rose Case, Raleigh, NC (US)

(73) Assignee: Lenovo (Singapore) Pte. Ltd., Singapore (SG)

(21) Appl. No.: 13/965,861

(22) Filed: Aug. 13, 2013

(51) Int. Cl. G06F 3/0488

(52) U.S. Cl. CPC G06F 3/04883
USPC 345/156

(57) ABSTRACT

An embodiment provides a method, including: ascertaining user input to a display screen forming a predetermined shape associated with system-wide note taking; determining, using one or more processors, user input note data associated with the predetermined shape; and providing, in a predetermined location, a note including the user input note data. Other aspects are described and claimed.

### BACKGROUND

Information handling devices (“devices”), for example smart phones, tablet devices, laptop and desktop computers, televisions, navigation systems, e-readers, etc., are used for a variety of tasks or activities. Often a user will be engaged in a first task or activity and, while working, wish to make a note for later consideration, similar to using a physical/paper POST-IT note to jot down a thought. POST-IT is a registered trademark of 3M Company in the United States and/or other countries.

Currently, devices are capable of storing electronic notes, although with some drawbacks. Commonly devices, e.g., tablets, smart phones, etc., are equipped with a note taking application that provides note taking functionality. Thus, if a user is performing one task, e.g., editing a word processing document, browsing a web page, etc., and wants to jot down a note for later consideration, the user will navigate away from the application associated with the first task, e.g., web browser, open the note application, write the note into the note application (e.g. enter key input or provide handwriting input, etc.), save it, and then return to the task.

### BRIEF SUMMARY

In summary, one aspect provides a method, comprising: ascertaining user input to a display screen forming a predetermined shape associated with system-wide note taking; determining, using one or more processors, user input note data associated with the predetermined shape; and providing, in a predetermined location, a note including the user input note data.

Another aspect provides an information handling device, comprising: a display screen; one or more processors; a memory storing instructions accessible to the one or more processors, the instructions being executable by the one or more processors to: ascertain user input to the display screen forming a predetermined shape associated with system-wide note taking; determine user input note data associated with the predetermined shape; and provide, in a predetermined location, a note including the user input note data.

A further aspect provides a program product, comprising: a storage medium having computer readable program code stored therewith, the computer readable program code comprising: computer readable program code configured to ascertain user input to a display screen forming a predetermined shape associated with system-wide note taking; computer readable program code configured to determine, using one or more processors, user input note data associated with the predetermined shape; and computer readable program code configured to provide, in a predetermined location, a note including the user input note data.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3(A-B) illustrates an example of system-wide handwritten note taking

FIG. 4 illustrates an example of a handwritten note located in a desktop view.

FIG. 5 illustrates an example method for system-wide handwritten note taking.

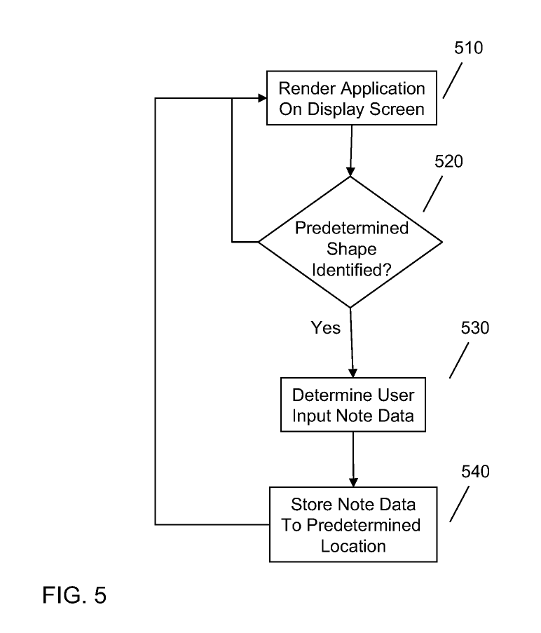

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

One of the most commonly reported pain points for a user is flow-interruption. Flow refers to the mental state in which the user is immersed in an activity or task, focused yet energized. Disrupting the smooth flow of thoughts or actions can result in data loss, annoyance and even frustration. Commonly, fleeting thoughts are often jotted down on POST-IT notes which can be stuck in highly visible places.

Using an information handling device, e.g., tablet, smart phone, etc., one can make a virtual note using an existing note taking application, and even use a digital pen or stylus to create it, e.g., via handwritten input to a touch screen or a digitizer. Unfortunately, the nature of the device environment makes jotting down a thought into such a note more complicated than in the context of a physical/paper note. The user must leave the application he or she is working in, find an appropriate application to take a typewritten or handwritten note in (e.g., close or minimize the running application) and return to the desktop), and then file/store the note in such a way that it can be found later. Applications that create notes or messages to the desktop exist; but like all applications they must be located and launched at a minimum before the user can begin note taking.

Accordingly, an embodiment provides methods by which a user may create a POST-IT style note (in a virtual or electronic form) within any application he or she is working in and have it automatically saved to a predetermined location, e.g., posted to the desktop, without leaving the original application. This facilitates in-line note taking wherein the user does not need to materially interrupt the flow of a current activity or task in order to perform note taking.

The illustrated example embodiments will be best understood by reference to the figures. The following description is intended only by way of example, and simply illustrates certain example embodiments.

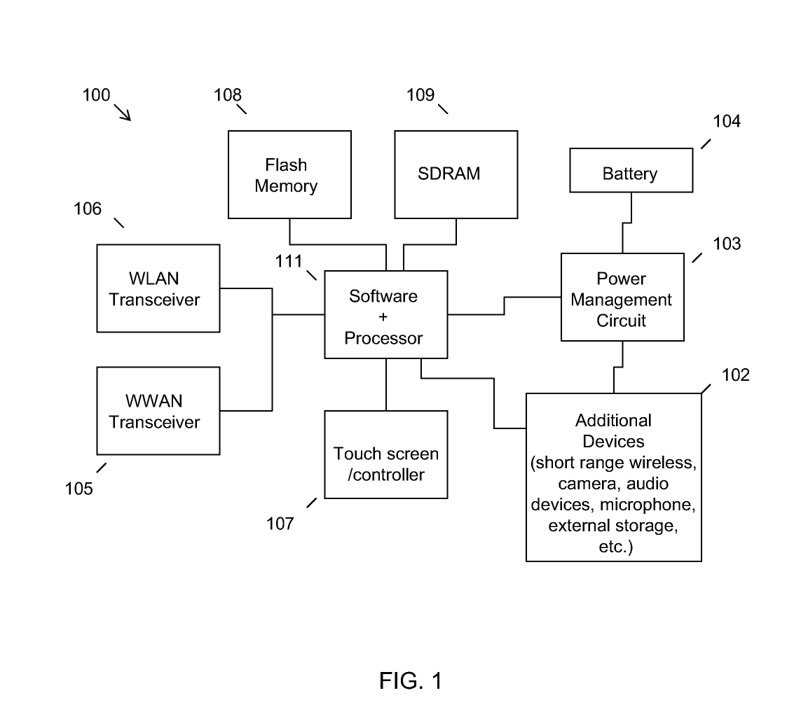

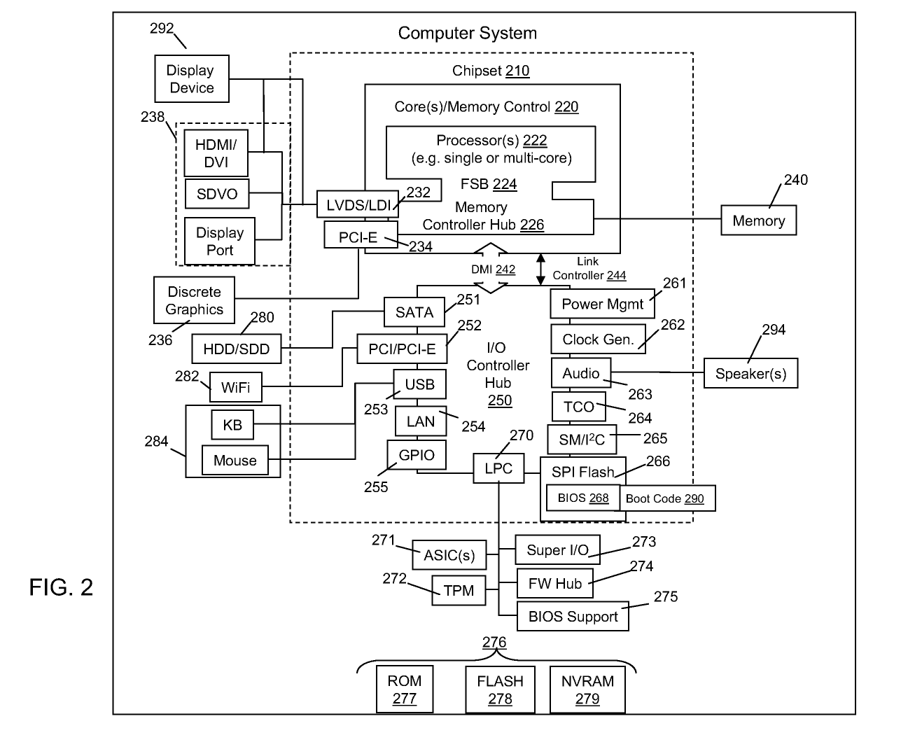

Referring to FIG. 1 and FIG. 2, while various other circuits, circuitry or components may be utilized in information handling devices, with regard to smart phone and/or tablet and/or any device with pen input circuitry 100, an example illustrated in FIG. 1 includes a system on a chip design found for example in tablet or other mobile computing platforms. Software and processor(s) are combined in a single chip 111. Internal busses and the like depend on different vendors, but essentially all the peripheral devices (102) may attach to a single chip 111. In contrast to the circuitry illustrated in FIG. 2, the circuitry 100 combines the processor, memory control, and I/O controller hub all into a single chip 111. Also, systems 100 of this type do not typically use SATA or PCI or LPC. Common interfaces for example include SDIO and I2C.

There are power management chip(s) 103, e.g., a battery management unit, BMU, which manage power as supplied for example via a rechargeable battery 104, which may be recharged by a connection to a power source (not shown). In at least one design, a single chip, such as 111, is used to supply BIOS like functionality and DRAM memory.

System 100 typically includes one or more of a WWAN transceiver 105 and a WLAN transceiver 106 for connecting to various networks, such as telecommunications networks and wireless base stations. Commonly, system 100 will include a touch screen 107 for data input and display. System 100 also typically includes various memory devices, for example flash memory 108 and SDRAM 109.

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling devices, as for example outlined in FIG. 1 and FIG. 2, may provide note taking functionality, as further described herein. In certain example embodiments described herein, the notes are handwritten notes and thus the device, such as devices outlined in FIG. 1 and FIG. 2, provides underlying technology to support handwritten input, e.g., providing a touch screen or digitizer that accepts stylus or pen inputs.

The most common method for launching an application, digital service or command is to click, tap or hover over a target (e.g., icon) on the screen. This requires the user to move the cursor or select the icon (e.g., with a finger or pen if using a touch screen). If the user is running a non-note taking application, e.g., a web browser or email application, the user needs to move or navigate out of a current application and onto the desktop or inside another application to achieve note taking. This disrupts the user's train of thought or flow, making it easy for the user to forget both the original thread of the idea and the new idea he or she wanted to jot down in a note.

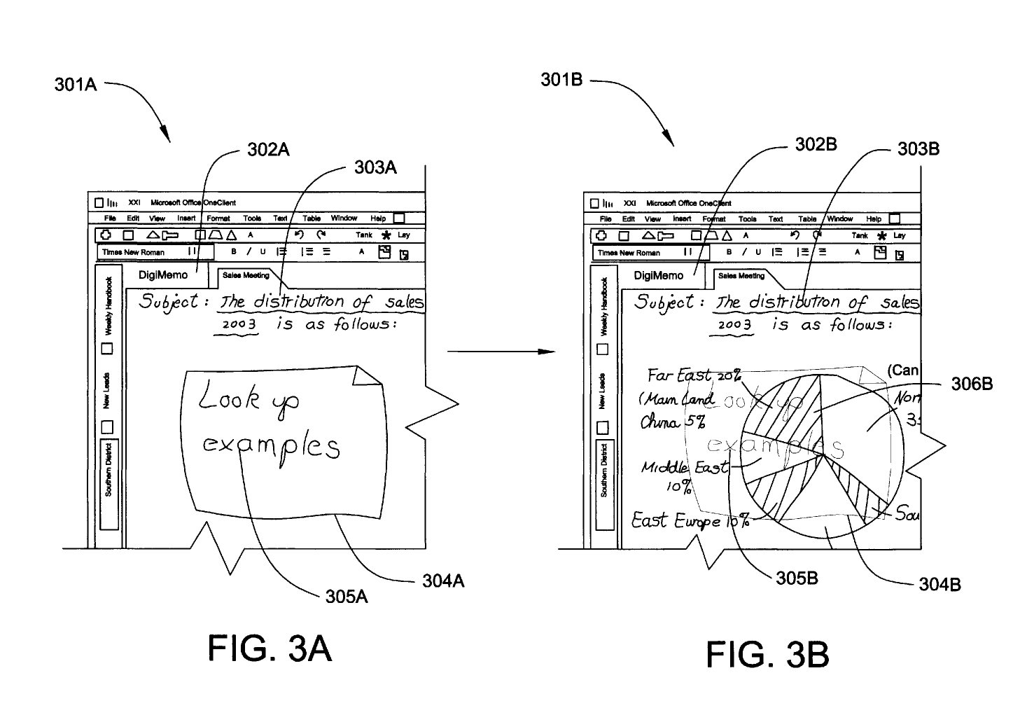

Accordingly, an embodiment allows a user to perform note taking in the current, running application. An embodiment provides a note taking function that is performed in a system-wide fashion, i.e., independent of the particular application that may be running. For example, referring to FIG. 3(A-B), a user may be working in a word processing application 302A rendered in a display screen 301A of a user device. It should be noted that this application is a non-limiting example and that the application may be a non-pen enabled application, e.g., one which accepts other user inputs, e.g., finger input, or the note taking functionality (as further described herein) may be provided when no particular application is running or when multiple applications are running. The word processing application may accept user input thereto, e.g., handwritten input 303A.

During the course of this activity, e.g., using a word processing application, a user may provide user input, e.g., using the pen as the command input device, to draw a predetermined shape 304A. An embodiment recognizes the user input predetermined shape 304A as a system oriented command associated with note taking and executes actions to implement note taking.

Thus, a user may provide note input or note data 305A (e.g., “Look up examples” in FIG. 3A) within the predetermined shape 304A. The user input note data 305A may be provided before the predetermined shape 304A is provided or after the predetermined shape 304A is provided. For example, a user may first provide input 305A and thereafter draw the predetermined shape 304A to bound or otherwise associate input 304A with note taking, i.e., indicative of the note data to be used. Alternatively, or additionally, the user may provide input 305A after the predetermined shape 304A has been provided. Thus, the user may first draw the predetermined shape 304A and thereafter provide note data or note input, e.g., within the boundary of the predetermined shape 304A.

An embodiment utilizes the recognition of the predetermined shape 304A as a trigger to associate input, e.g., input 305A, with a note taking activity. For example, an embodiment may consider inputs provided within predetermined shape 304A as the note data or note input 305A. This data, e.g., 305A, may thus be stored as a note by an embodiment.

Once the user input data, e.g., 305A, is associated with note taking and stored as a note, the note data, e.g., 305A, may remain within the rendered display along with other application data derived from user inputs, e.g., 303A. Alternatively, the user input note data, e.g., 305A, may be removed from the rendered display, e.g., via an animation or some other mechanism. In one embodiment, illustrated in FIG. 3B, the user input note data 305B and the predetermined shape 304B are each removed from the application 302B of the display screen 301B by an animation of the note data 305B and predetermined shape 304B fading into the background in a timed fashion. The note data 305B and the predetermined shape 304B may thus be completely removed or partially removed from the rendered display. This permits the user to continue to add data, e.g., data 306B to the application 302B rendered in the display 301B.

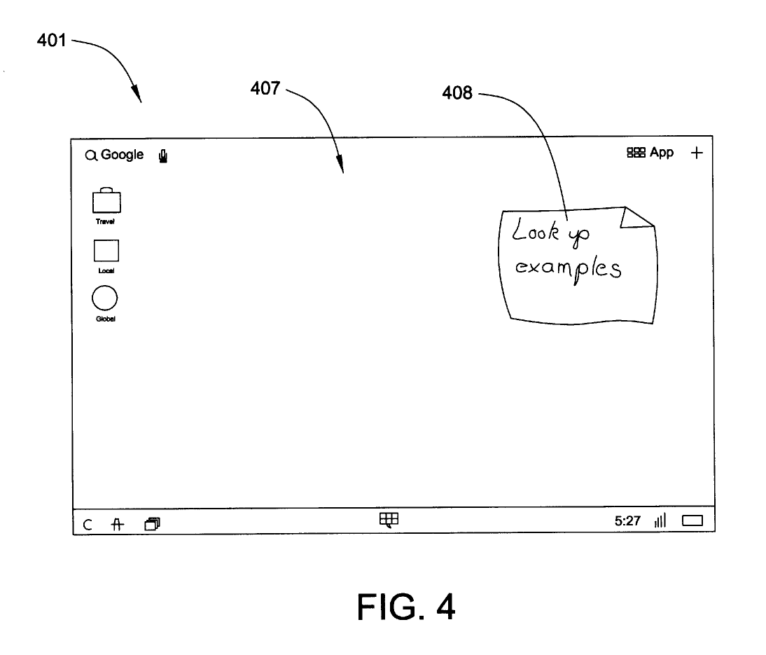

With reference to the predetermined location to which the note is saved, an embodiment may save the note to a predetermined location that will catch the attention of the user making the note. For example, referring to FIG. 4, an embodiment may save the note 408 including the note data input by the user, e.g., note data 305A, to a desktop view 407, e.g., as rendered on a display screen 401 of a device once all applications have been closed. Thus, the note 408 (corresponding to 305A) is pinned to the desktop view 407 such that it catches the user's attention. Other alternatives are possible, for example providing a reminder of a note, e.g., in a pop-up window, such that the user's desktop view 407 does not contain note 408, or a suitable combination of the foregoing.

An embodiment therefore saves the user the trouble of jumping out of the running application, launching a note application, and performing note taking functions. In addition, an embodiment allows the user to stay in the flow of his or her work without worrying about how to find the note 408 in the future, as it will be waiting on the desktop view 407.

For example, a user operating an application that is rendered on a display screen 510 may simply provide the predetermined shape 520 in order to signify that a note should be taken. This predetermined shape, if identified at 520, permits an embodiment to associate or determine note data 530, either already bound or otherwise indicated by the predetermined shape (e.g., as thereafter provided into an area bound by the predetermined shape). The determined note data thus may be used to create a note that is stored in a convenient, predetermined location 540. In the event where a user provides data to the predetermined shape 520 after forming it, a user first creates the predetermined shape 520. The predetermined shape 520 may be associated with a space in the current open application. As the user changes what is in the space, the note on the desktop mirrors the changes. Then, a user may provide input, e.g., a pen gesture to remove the note from the application, with the mirrored note going away (e.g., via predetermined fading) and the note, e.g., posted to the desktop, is not linked to the application data of the area anymore (i.e., the note taking process is completed).

The note taking function need not disturb the user such that, according to an embodiment, a note may be taken during the running of any application and the user may return to using the application after the note has been taken. As described herein, the process may include keeping the note information in the running application (or displayed in a view overlaying the application) or removed, e.g., via an animated sequence such as slowly fading away or the like. This promotes efficient work flow where the user may take notes during the use of an application without necessitating an interruption in the application. Moreover, an embodiment is implemented in a system wide fashion such that, in any running application, a note may be taken and stored without interrupting the given application to launch a dedicated note application.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
ascertaining user input to a display screen forming a predetermined shape associated with system-wide note taking;
determining, using one or more processors, user input note data associated with the predetermined shape; and
providing, in a predetermined location, a note including the user input note data.

2. The method of claim 1, wherein the determining comprises determining user input note data bounded by the predetermined shape.

3. The method of claim 2, wherein the user input note data bounded by the predetermined shape comprises note data input by a user after the ascertaining the predetermined shape.

4. The method of claim 1, wherein the user input note data remains in an application rendered in the display screen after the user input note data is provided in the predetermined location.

5. The method of claim 1, further comprising determining additional user input note data associated with the predetermined shape; and updating the note based on the additional user input note data.

6. The method of claim 1, wherein the user input note data is removed from an application rendered in the display screen.

7. The method of claim 6, wherein the user input note data is removed from the application rendered in the display screen by a fading animation.

8. The method of claim 1, wherein the predetermined location is accessible from a desktop view of an information handling device.

9. The method of claim 8, wherein the user input note data provided in the predetermined location comprises user input note data bounded by the predetermined shape selected from the group consisting of a screen capture; handwritten user input, and machine readable text input.

10. The method of claim 1, wherein the predetermined shape is ascertainable within any application such that the predetermined shape is associated with system-wide note taking in an application-independent manner.

11. An information handling device, comprising:
a display screen;
one or more processors;
a memory storing instructions accessible to the one or more processors, the instructions being executable by the one or more processors to:
ascertain user input to the display screen forming a predetermined shape associated with system-wide note taking;
determine user input note data associated with the predetermined shape; and
provide, in a predetermined location, a note including the user input note data.

12. The information handling device of claim 11, wherein to determine comprises determining user input note data bounded by the predetermined shape.

13. The information handling device of claim 12, wherein the user input note data bounded by the predetermined shape comprises note data input by a user after the ascertaining the predetermined shape.

14. The information handling device of claim 11, wherein the user input note data remains in an application rendered in the display screen after the user input note data is provided in the predetermined location.

15. The information handling device of claim 11, wherein the instructions are further executable by the one or more processors to determine additional user input note data associated with the predetermined shape; and update the note based on the additional user input note data.

16. The information handling device of claim 11, wherein the user input note data is removed from an application rendered in the display screen.

17. The information handling device of claim 16, wherein the user input note data is removed from the application rendered in the display screen by a fading animation.

18. The information handling device of claim 11, wherein the predetermined location is accessible from a desktop view of the information handling device.

19. The method of claim 11, wherein the predetermined shape is ascertainable within any application such that the predetermined shape is associated with system-wide note taking in an application-independent manner

20. A program product, comprising:
a storage medium having computer readable program code stored therewith, the computer readable program code comprising:
computer readable program code configured to ascertain user input to a display screen forming a predetermined shape associated with system-wide note taking;
computer readable program code configured to determine, using one or more processors, user input note data associated with the predetermined shape; and
computer readable program code configured to provide, in a predetermined location, a note including the user input note data.
